(19) United States
(12) Patent Application Publication
(10) Pub. No.: US 2003/0233538 A1
(43) Pub. Date: Dec. 18, 2003

(54) System for dynamic, scalable secure sub-grouping in mobile ad-hoc networks

(76) Inventor: Bruno Dutertre, Mountain View, CA (US)

Correspondence Address: SUGHRUE MION, PLLC, 1010 El Camino Real, Menlo Park, CA, 94025-4345, US

(21) Appl. No.: 10/185,961

(22) Filed: Jun. 28, 2002

Related U.S. Application Data
(60) Provisional application No. 60/384,662, filed on May 31, 2002.

(51) Int. Cl. H04L 9/00

(52) U.S. Cl. 713/151; 713/200

(57) ABSTRACT

Invention provides MANET plus VPN: secure virtual private subgroups communicating within a mobile ad hoc network. Wireless communication system is taught suitable for ad hoc mobile wireless as well as mesh and peer to peer networks. Also taught relative to MANET is an embodiment wherein network protocols, including TBRPF, are employed at the network layer, and upon which another layer, Enclaves, provides capability for secure VPN (virtual private networks) within the MANET.

Dynamic group management capability, intrusion tolerant Enclaves, with multi leader and multi casting TBRPF layer coupled with Enclaves layer (VPN) are taught as inventive embodiments.

This application claims priority from U.S. application Ser. No. 09/844,693 filed Apr. 26, 2001 and from provisional application Nos. 60/247,488 and 60/247,184 filed Nov. 8, 2000, and from provisional No. 60/384,662 filed May 31, 2002, incorporated herein in their entirety.

### GOVERNMENT FUNDING

The invention was made with Government support under contract Number N66001-00-C-8001 awarded by Space and Naval Warfare Systems Center. The Government has certain rights in this invention

### FIELD OF THE INVENTION

The invention relates to secure communication within mobile ad-hoc networks. The invention also relates to secure communication in mesh networks and peer to peer networks.

### BACKGROUND

Secure communication among sub-group of the members of a network is achieved in different manners but the result is often termed a “virtual private network” or VPN. Communications among members of a VPN are typically automatically encrypted using secure keys known to members of the group as a means of achieving group privacy. Generally, as the number of member increase, and the membership is highly dynamic, with joining and leaving members, the management of keys is burdensome. The burden on group management creates a susceptibility to single point of failure.

It is possible to further envision challenges to management of dynamic subgroups in distributed wireless ad hoc networks if each communicating member as a nodes functioning in a civil disaster or emergency relief or military scenario. The robustness of the network depends on the sub-groups secures communication to persist despite the loss of membership or compromises to the security of any number of nodes, including nodes acting as leaders.

Moreover, robustness must translate to verification of content and source. Methods are available, but often require computational capacity that outstrips the capability of mobile wireless nodes. The wireless and mobile attributes of the member nodes as well as the lightweight power and computing capabilities of distributed nodes make the sort of absolute security possible in non-wireless/non-mobile systems completely impractical.

What is needed is lightweight, secure distributed sub-grouping capabilities within mobile wireless ad hoc networks. Further needed is the ability of such capabilities to optimally blend with network protocols to ensure security and to preserve communication viability in highly dynamic and severely un-optimized configurations.

### SUMMARY OF THE INVENTION

The invention provides a network communication system that provides secure collaborative group communication among a subset of nodes in a mobile ad hoc network (MANET). The invention provides a method for such a system, the method going beyond the steps of determining the membership of the MANET; calculating a path from each node contained within said mobile ad-hoc MANET to each other node within said mobile ad hoc MANET, to inventively create a secure virtual communication channel between each member node of said subset of nodes; and to manage the membership of said subset as it changes over time. The invention in a preferred embodiment provides that this secure communication can be performed using TBRPF (Topology Based Reverse Path Forward) network layer protocol. The preferred embodiment also provides that the group management of the plurality of interconnected nodes engaged in communicating amongst the member nodes within a VPN includes two or more leader nodes cooperatively exerting management over discrete sub-groups so as to collectively manage membership in the group as a whole.

The invention further provides a means of ensuring intrusion tolerant authentication and key management capabilities for ad hoc mobile wireless networks. In an alternate embodiment, such capabilities can also be applied to large-scale self-organizing networks of small-embedded device. In the preferred embodiment, the inventive approach utilizes authentication and key management using only inexpensive cryptographic primitives (no public key cryptography), does not require servers, and has very small configuration overhead.

The invention further provides multicast routing capability from the nodes of the TBRPF enabled VPN.

### BRIEF DESCRIPTION OF THE DRAWINGS

FIGS. 1A through E inclusive illustrates TBRPF neighbor discovery in a mobile network

FIGS. 2A through D illustrates Enclaves enablement of VPN

FIGS. 3A through B inclusive illustrate TBRPF and Enclaves in a MANET

FIG. 4 illustrates conceptually intrusion tolerance according to the invention

FIG. 5 Omitted

FIGS. 6A and B: Exemplars of TBRPF headers for PRUNE & GRAFT in multicast

### DETAILED DESCRIPTION OF THE PREFERRED EMBODIMENT

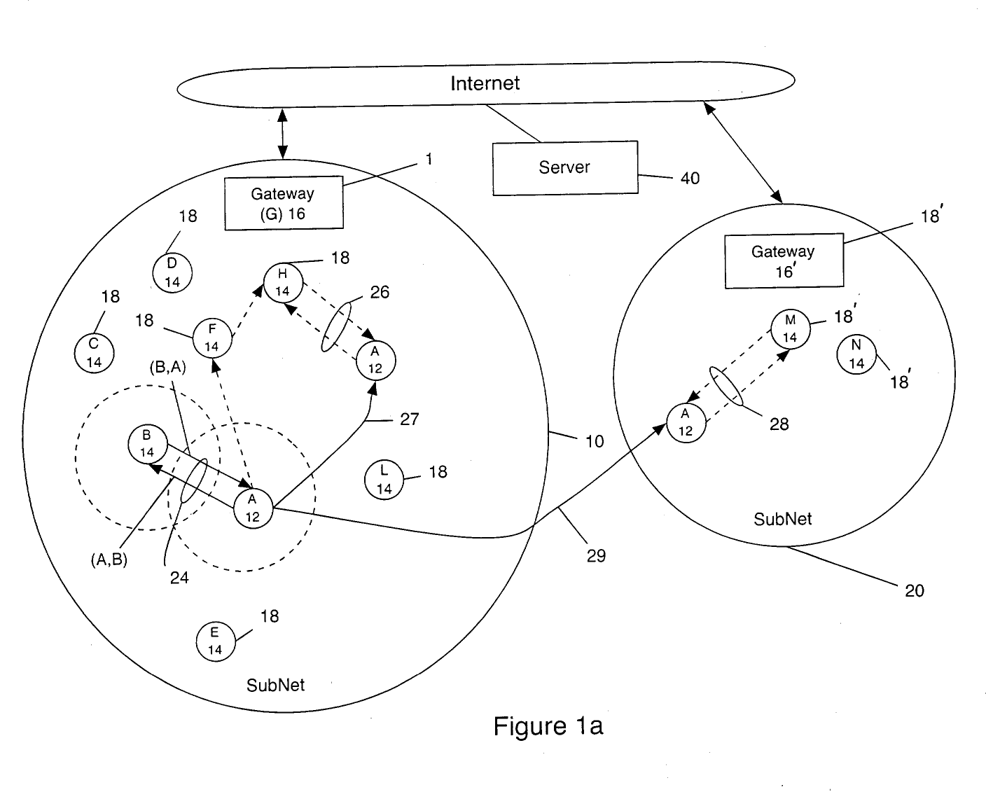

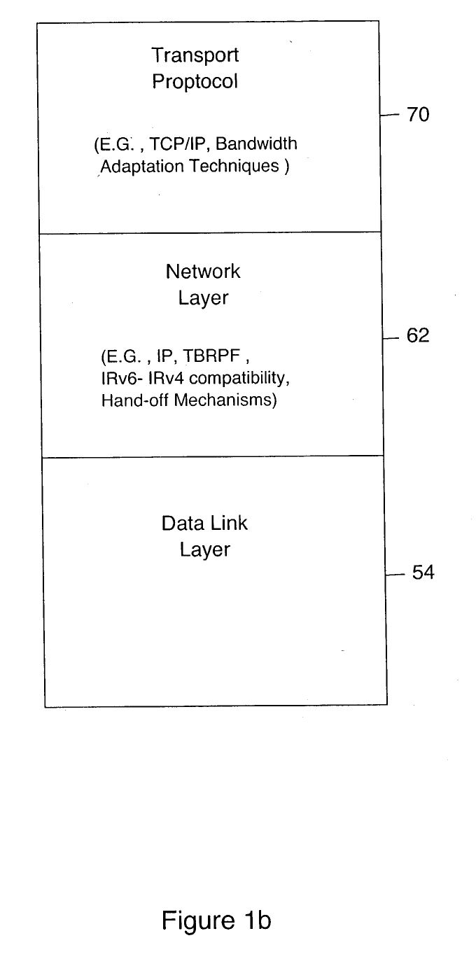

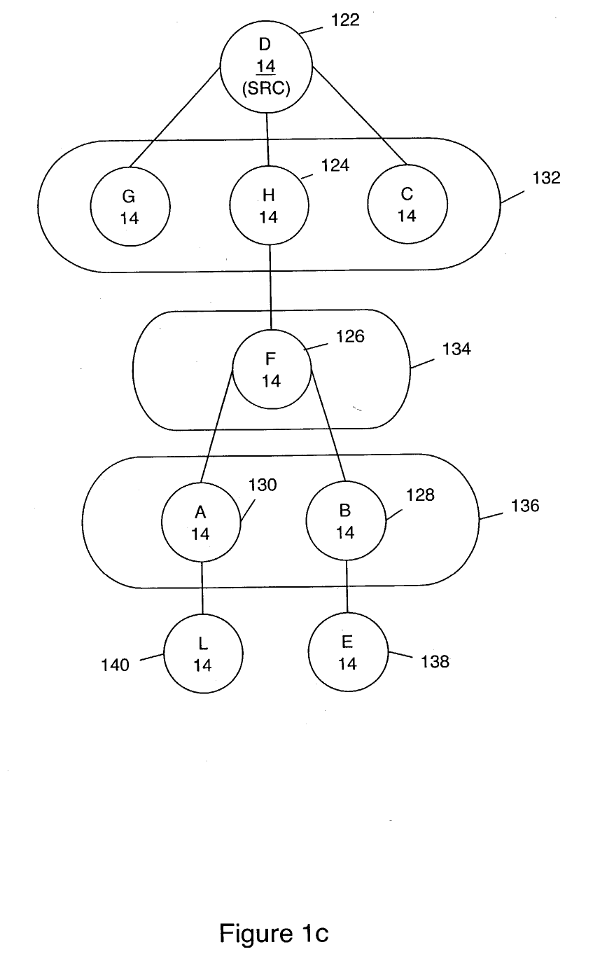

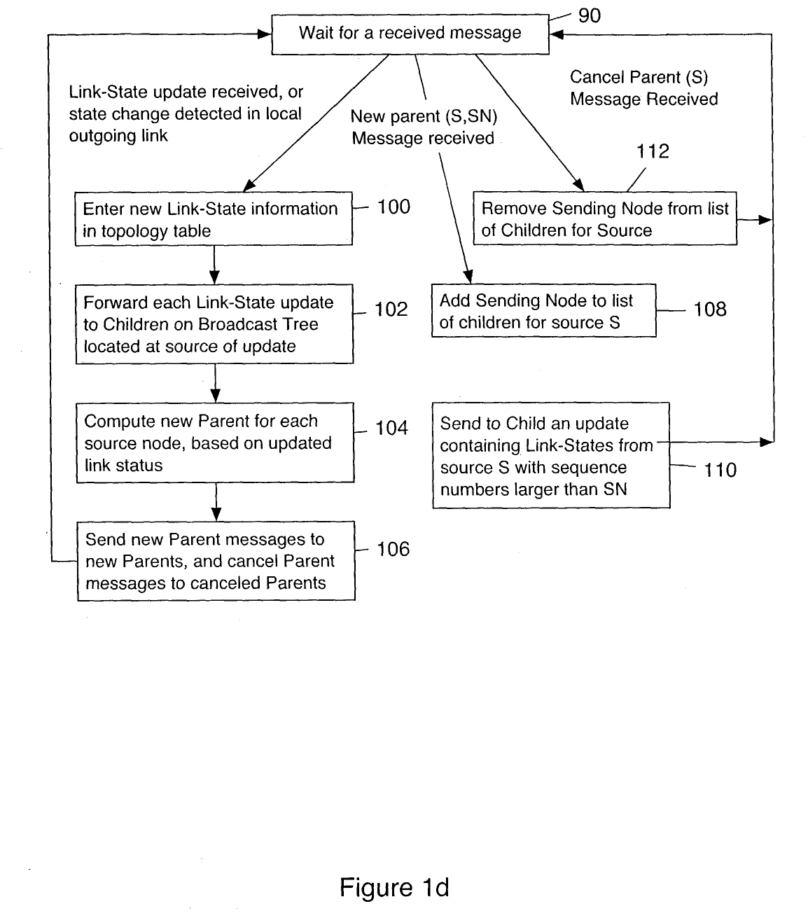

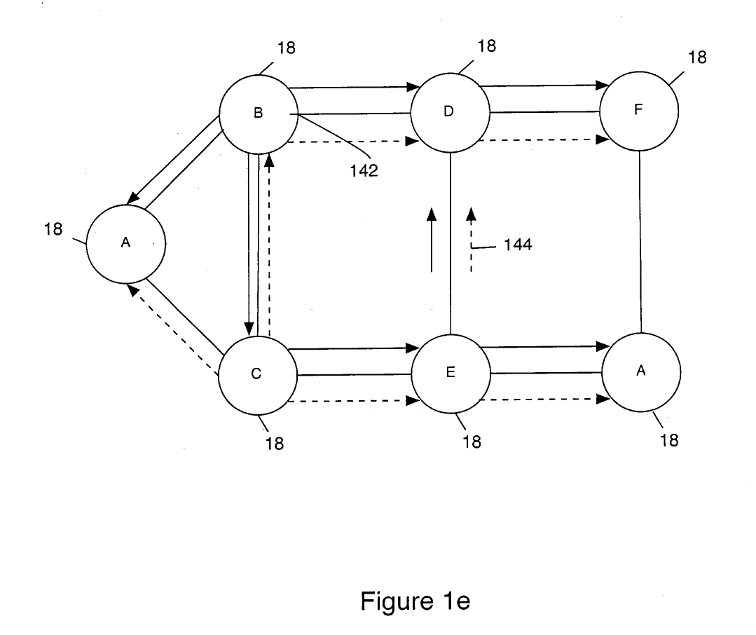

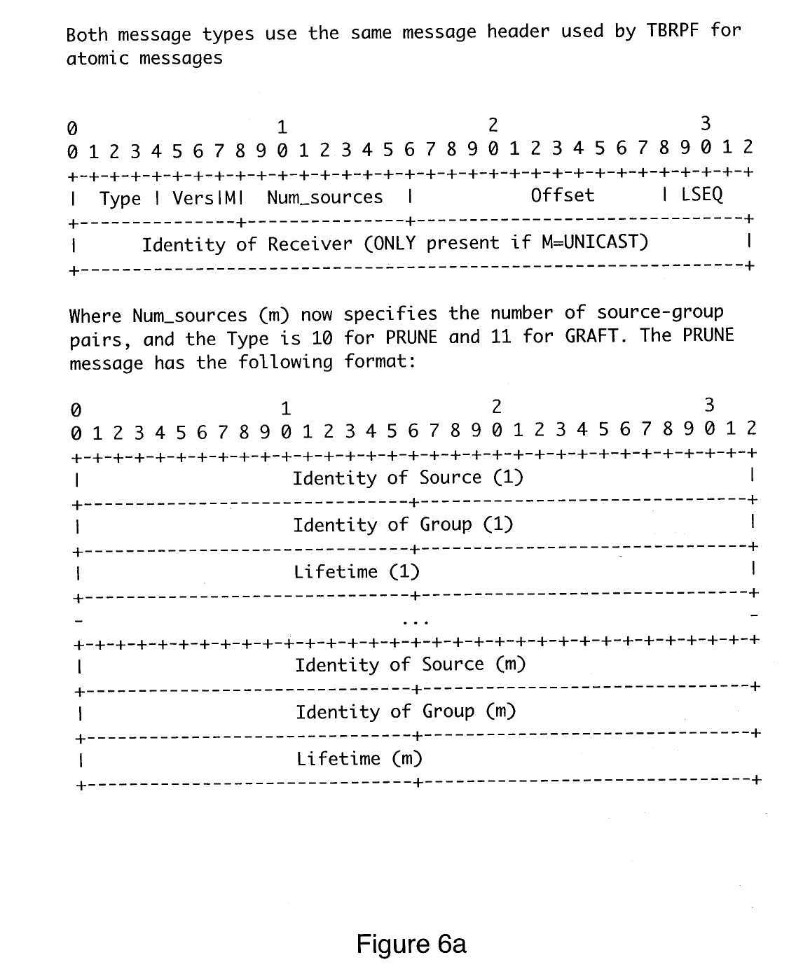

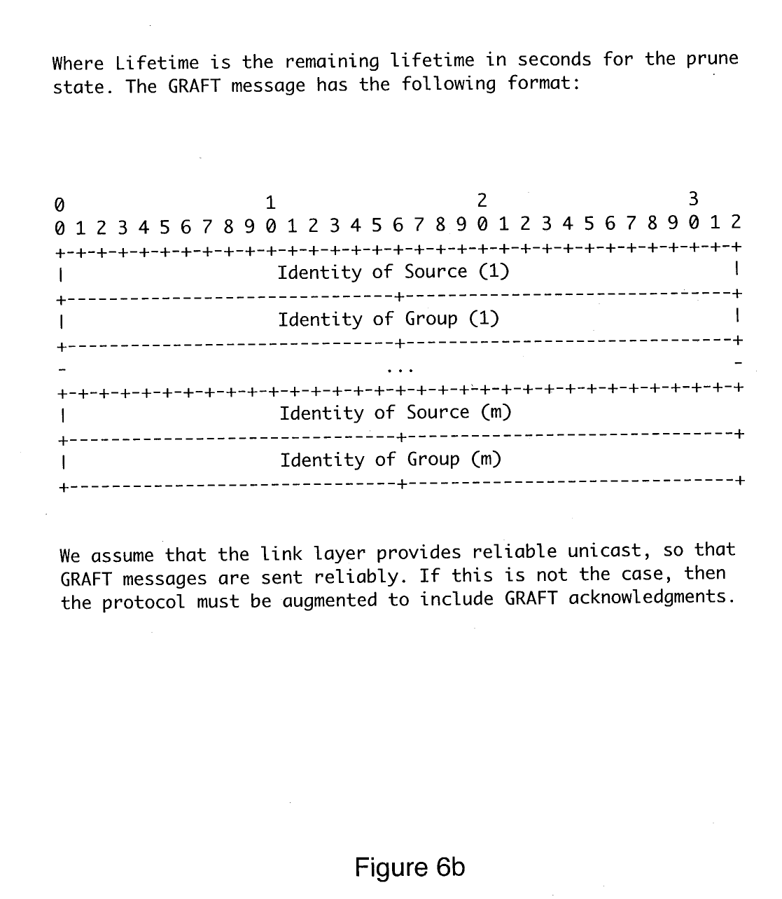

A brief discussion of TBRPF as it relates to this invention, may be obtained by referring to FIGS. 1A through E taken in light of Appendix A, which is incorporated by reference as if fully set forth herein. TBRPF multi casting is further described in Appendix B, which is incorporated by reference into this detailed discussion in its entirety. And TBRPF multicast headers are exemplified in FIGS. 6A and B.

Enclaves^{sm1} Services Enclaves is used by Assignee, SRI, International to denotes proprietary software as described herein and set forth in

A group-oriented application enables users to share information and collaborate via a communication network such as the Internet. Enclaves^{sm} is a lightweight software infrastructure that provides security services for such applications. See Li Gong Enclaves: Enabling Secure Collaboration over the Internet; IEEE Journal in Selected Areas on Communications; 11, (5): 657-663, June 1993. Enclaves^{sm} provides services for creating and managing groups of users of small to medium sizes, and enables the group members to communicate securely. Access to an active group is restricted to a set of users who must be pre-registered, but the group can be dynamic: authorized users can freely join, leave, and later rejoin an active application.

The communication service implements a secure multicast channel that ensures integrity and confidentiality of group communication. All messages originating from a group member are encrypted and delivered to all the other members of the group. For efficiency reasons, Enclaves^{sm} provides best-effort multicast and does not guarantee that messages will be received, or received in the same order, by all members. This is consistent with the goal of supporting collaboration between human users, which does not require the same reliability guarantees as distributing data between servers or computers.

The group-management services perform user authentication, access control, and related functions such as key generation and distribution. All group members receive a common group key that is used for encrypting group communication. A new group key is generated and distributed every time the group composition changes, that is, whenever a user enters or leaves the group. Optionally, the group key can also be refreshed on a periodic basis. Enclaves also communicates membership information to all group members. On joining the group, a member is notified of the current group composition. Once in the group, each member is notified when a new user enters or a member leaves the group. Thus, all members know who is in possession of the current group key.

In summary, Enclaves enables users to be authenticated and to join a groupware application. Once in a group, a user A is presented with a group view, that is, the list of all the other group members. The system is intended to satisfy the following security requirements:

a) Proper authentication and access control: Only authorized users can join the application and an authorized user cannot be prevented from joining the application.

b) Confidentiality of group communication: Messages from a member A can be read only by the users who were in A's view of the group at the time the message was sent.

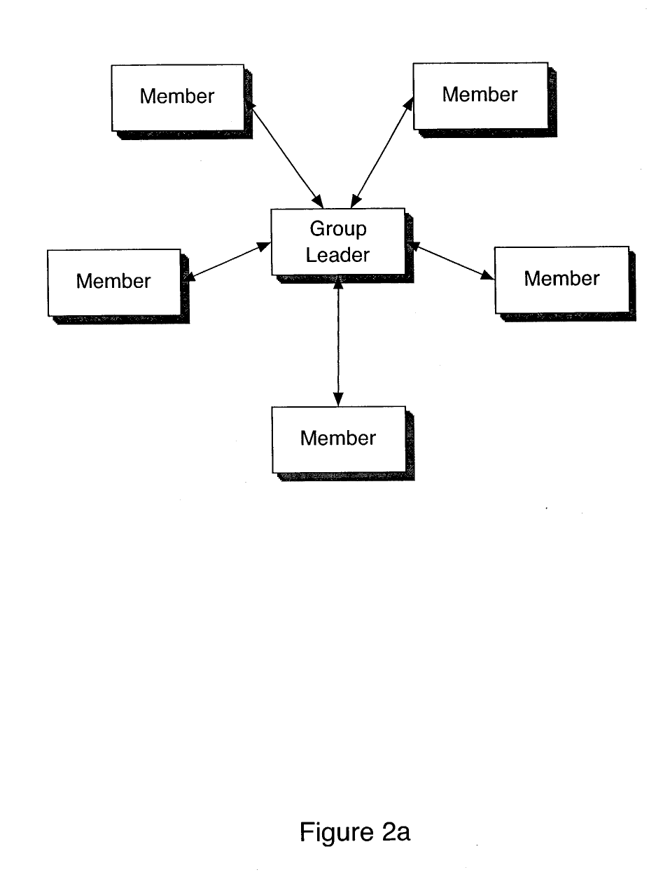

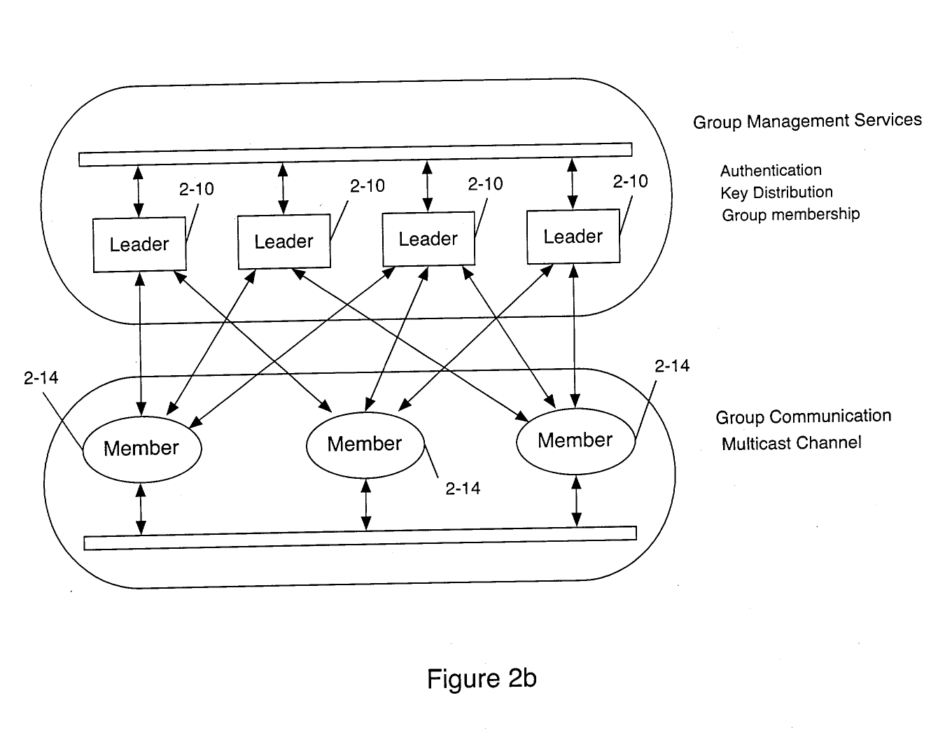

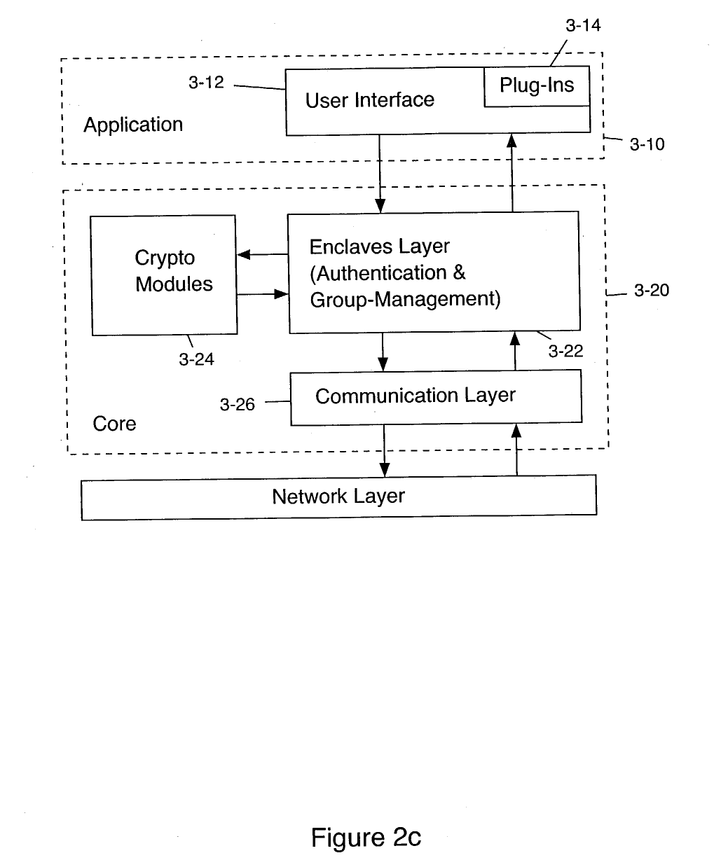

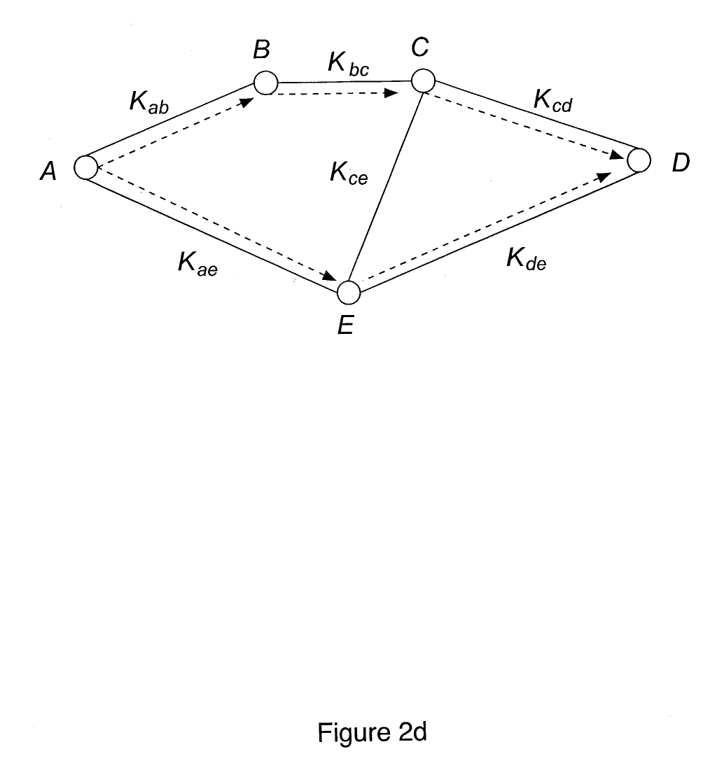

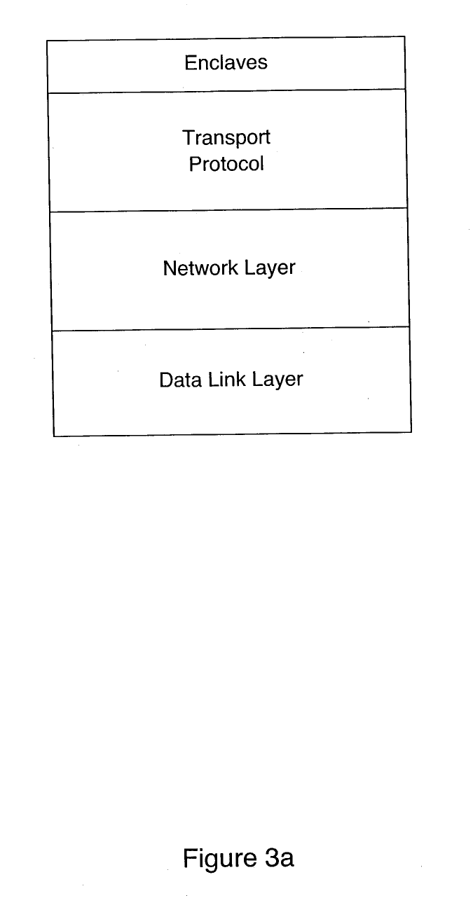

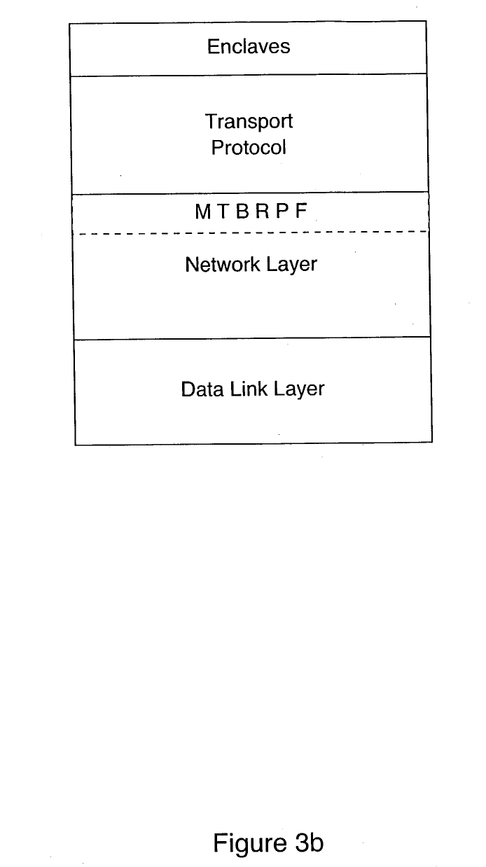

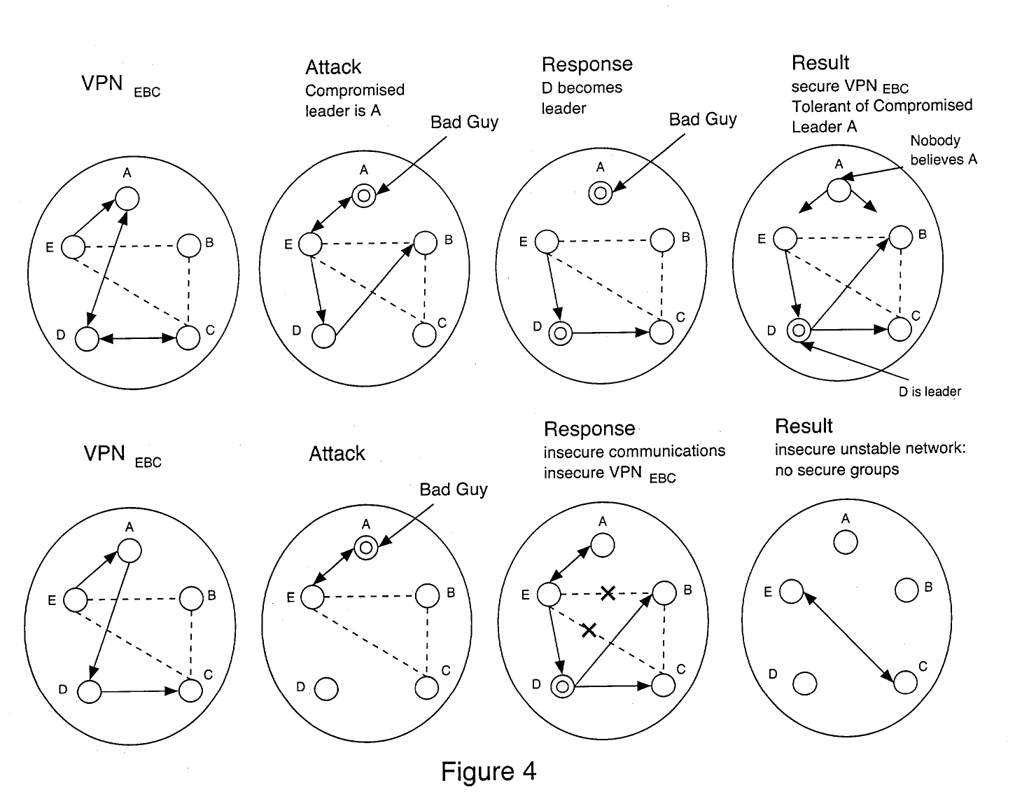

c) Integrity of group communication: A group message received by A was sent by a member of A's current view, was not corrupted in transit, and is not a duplicate. FIGS. 1A through E inclusive, depict TBRPF and FIG. 2A the original Enclaves. FIGS. 3A and B depict the conceptual layers of a network system according to the present invention. The invention couples wireless protocol expertise (eg.TBRPF) and authentication protocols and key management.

Centralized Architecture

The original version of Enclaves relies on the centralized architecture shown in FIG. 2A. In this architecture, a single group leader is responsible for all group-management activities. The leader is in charge of authenticating and accepting new group members, generating group keys and distributing them to members, and distributing group membership information.

Multi Leader Architecture

The architecture of the wireless version of Enclaves is shown in FIGS. 2B-D. The group and key management functions are distributed across n leaders. The leaders 2-10 communicate with each other and with users via an asynchronous network. Messages sent on this network are assumed to be eventually received, but no assumptions are made on the transmission delays and on the order of reception of messages.

Mobile networks require rapid group association and key deployment. As in previous Enclaves implementations, a common group key is shared by the group members. A new key is generated by the leaders whenever the group changes.

In its dynamic wireless form provided by the invention taught herein, Enclaves can provide a VPN for wireless networks because it removes pre-specified leaders and pre-registered users. It decentralizes authentication and joins protocols. The authentication is based on certificates and public key cryptography. And the key management protocols are novel.

The VPN component is achieved through leveraging VPN technology to create portable, secure, intrusion tolerant, lightweight software infrastructure. Such an infrastructure is based upon fault-tolerant algorithms and cryptography. Groups are managed by predefined sets of leaders.

The dynamic aspect is accomplished by removing the requirement of predefined leaders so that the network is dynamically reconfigurable for increased security and intrusion tolerance. The deployment on ad-hoc wireless networks increases the dynamic character. Organizing groups in clusters serves to further compartmentalize communication and also conserves bandwidth.

Wireless Enclaves also includes protocols for robust and secure multicast.

The preferred embodiment also includes support for multiple secure groups. Authentication, key management and multicast require collaboration of nodes from different groups. Moreover, group hierarchy and clustering is achieved through communication filtering, adapting organization to dynamic network environment, and changing cluster to reduce communication cost.

Scalability of dynamic Enclaves is demonstrable in the protocols set forth and otherwise described herein.

The architecture is designed to tolerate up to f compromised leaders, where 3f+1≦n.

The security requirements are the same as previously, and assume that a fixed list of authorized participants is specified before an application starts. The new objective is now to ensure that these requirements are satisfied even if up to f leaders are compromised.

For proper group management, any modification of the group composition requires agreement between the nonfaulty leaders. These leaders must agree before accepting a new member or determining that an existing member has left. Ideally, one would like all nonfaulty leaders to maintain agreement on the group composition. Unfortunately, this requires solving a consensus problem, in an asynchronous network, under Byzantine faults. As is well known, there are no deterministic algorithms for solving this problem. Randomized algorithms or algorithms relying on failure detectors could be applicable, but these algorithms tend to be complex and expensive. Instead, a weaker form of consistency property is sufficient for satisfying Enclave's security requirements. The algorithm used in this embodiment is similar to consistent broadcast protocols. Combined with an appropriate authentication procedure, this al-gorithm ensures that any authorized user who requests to join the group will eventually be accepted. Unlike Byzantine agreement, this algorithm does not guarantee that users are accepted in the same order by all leaders. However, this does not lead to a violation of the confidentiality or integrity properties. If the group becomes stable, all non-faulty leaders eventually reach a consistent view of the group.

As in previous Enclaves implementations, a common group key is shared by the group members. A new key is generated by the leaders whenever the group changes. The difficulty is to generate and distribute this key in an intrusion-tolerant fashion. All group members must obtain the same valid group key, despite the presence of faulty leaders. The attacker must not be able to obtain the group key even with the help off faulty leaders. These two requirements are satisfied by using a secret sharing scheme proposed by Cachin et al. In the Enclaves framework, this scheme is used by leaders to independently generate and send individual shares of the group key to group members. The protocol is configured so that f+1 shares are necessary for reconstructing the key. A share is accompanied with a description of the group to which it corresponds and a “proof of correctness” that is computationally hard to counterfeit. This allows group members to obtain strong evidence that a share is valid, and prevents faulty leaders from disrupting group communication by sending invalid shares.

To join an application, a user A must contact 2f+1 leaders. Once in the group, A remains connected to these leaders and receives key and group update messages from them. A majority of consistent messages (i.e., f+1) must be received before A takes any action. For example, A changes its current group key only after receiving at least f+1 valid key shares from distinct leaders, and checking that these shares correspond to the same group description. This ensures A that the new group key is valid and that at least one share came from a nonfaulty leader.

Intrusion tolerance in Enclaves relies then on the combination of a cryptographic authentication protocol, a Byzantine fault-tolerant leader-coordination algorithm, and a secret sharing scheme. These protocols are presented in greater detail in the section that follows.

Preferred Embodiment

Enclaves according to the invention taught herein —that can provide secure dynamic multicast groups on mobile wireless networks—is currently implemented in Java, using Sun Microsystems' Java 2 SDK 1.3.1 and the Cryptix 3.2 cryptographic libraries. (See http://www.cryptix.org) The source consists of around 9,000 lines of code in approximately 100 classes.

The software is organized in two main modules as depicted in FIGS. 2-C. A set of classes implements the core Enclaves functionalities, namely, the authentication, group management, and key-management functions described previously. On top of this basis, a user interface is available that can be customized to support diverse applications. The interface allows users to authenticate and log in to an Enclaves group and displays status information, including the list of members. Applications can be easily incorporated into this interface via a “plugin” mechanism.

Core Enclaves

The core classes implement the protocols and algorithms described previously. These classes are organized in an Enclaves layer responsible for authentication and group management services, a cryptographic module, and a communication layer that interface with Java networking functions. In a current embodiment, group communication (between group members) as well as communication between leaders is implemented using IP multicast. Leader-to-client connections rely on TCP.

The preferred embodiment of Enclaves uses Cryptix 3.2 as a cryptographic module, but other providers complying with the Java Security Architecture can be used. Enclaves uses a symmetric-key encryption algorithm (currently triple DES), a digital signature algorithm (DSA), and secure hashing algorithm (SHA). These can be easily replaced by other algorithms with similar functionality.

Plugins

Enclaves provides a simple user interface that can be customized for various applications via the use of “plugins”. The plugins are loaded on startup and executed, as the user requires. This architecture allows several applications to coexist and run concurrently in the same Enclaves group. The underlying support classes transparently encrypt all application messages and distribute them to all group members. Conversely, messages received from the group are de-crypted and dispatched to the relevant plugin.

Protocols

The protocols currently used in the preferred embodiment are set forth. While there is a strong emphasis on intrusion tolerance as a feature, notwithstanding, the characteristics of the preferred embodiment should not be interpreted as limitations on the invention as taught herein.

Authentication

To join the group, a user A must first initiate an authentication protocol with 2f+1 distinct leaders. A is accepted as a new group member if it is correctly authenticated by at least f+1 leaders. This ensures that f faulty leaders cannot prevent an honest user from joining the group, and conversely that f faulty leaders cannot allow an unauthorized user to join the group.

For authentication purposes, all users registered as authorized participants in an application share a long-term secret key with each leader. If Lᵢ is one of the leaders, A has a long-term key P_{a,i} that is known by Lᵢ and A. In the current implementation, P_{a,i} is computed from A and Lᵢ's identities, and A's password by applying a one-way hash function. This ensures with high probability that two distinct leaders Lᵢ and Lⱼ do not have the same key for A. Intrusion at a leader Lᵢ can reveal key P_{a,i} to the attacker but does not reveal A's password or Pₐⱼ. Thus, access to up to f long-term keys P_{a,i} does not enable an attacker to impersonate A.

The following protocol is used by A to authenticate with Lᵢ

| | |
|---|---|
| 1. A→Lᵢ: | AuthInitReq, A, L₁, {A, Lᵢ, N₁, }P_{a,b} |
| 2. L₁→A: | AuthKeyDist, L₁, A, {L₁, A, N¹, N₂, Ka,i}P_{a,i} |
| 3. A→L₁: | AuthAckKey, A, Lᵢ, {N₂, N₃}K_{a,i} |

As a result of this exchange, A is in possession of a session key K_{a,i} that has been generated by Lᵢ. All group management messages from Lᵢ to A are encrypted with K_{a,i} Thus, a secure channel is set up between A and Lᵢ that ensures confidentiality and integrity of all group-management messages from Lᵢ to A. Nonces and acknowledgments protect against replay. The key K_{a,i} is in use until A leaves the group. A fresh session key will be generated if A later rejoins the group.

Leader Coordination

If a non-faulty leader Lᵢ successfully authenticates A, Lᵢ does not immediately add A as a new group member. Instead, the leader coordination algorithm described in FIG. 3 is executed. A similar algorithm is used to coordinate leaders when a member leaves the group.

Leader L, runs the following protocol

After successful authentication of A,

Lᵢ sends (Propose, j, A, nⱼ)_{σj} to all leaders

After receiving f+1 valid (Propose, j, A, nⱼ)_{σj}

from different leaders, Lᵢ sends (Propose, i, A, ni)_{σ,I}

to all leaders if it has not already done so When Li receives n−f valid (Propose, j, A, nⱼ)_{σj}

from n−f distinct leaders, Lᵢ accepts A as a new member

Leader Coordination Protocol

The notation ( . . . )_{σi} denotes a message digitally signed by Lᵢ. The constant nᵢ is used to protect against replay attacks. Each leader maintains a local integer variable nᵢ and its local view Mᵢ of the current group members. Mᵢ is updated and nᵢ is incremented every time Lᵢ accepts a new member or removes an existing member. The message (Propose, A, nⱼ, is considered valid by Lᵢ if the signature checks, if nⱼ≧nᵢ, and if A is not a member of Mᵢ. The pair (nᵢ, Mᵢ) is Lᵢ's current view of the group. In FIG. 3, Lᵢ must include its own (Propose . . . ) message among the n-f messages necessary before accepting A.

This algorithm is a variant of existing consistent broadcast algorithms. It satisfies the following properties as long as no more than f leaders are faulty:

Consistency: If one non-faulty leader accepts A then all non-faulty leaders eventually accept A.

Liveness: If f+1 non-faulty leaders announce A, then A is eventually accepted by all non-faulty leaders.

Valid Authentication: If one non-faulty leader accepts A then A has been announced, and thus authenticated, by at least one non-faulty leader.

The last property prevents the attacker from introducing unauthorized users into the group. Conversely, if A is an authorized user and correctly executes the authentication protocol, A will be announced by f+1 non-faulty leaders, and thus will eventually be accepted as a new member by all non-faulty leaders.

The protocol works in an asynchronous network model where transmission delays are unbounded. It does not ensure that all non-faulty leaders always have a consistent group view. Two leaders Lᵢ and Lⱼ may have different sets Mᵢ and Mⱼ for the same view number nᵢ=nⱼ. This happens if several users join or leave the group concurrently, and their requests and the associated Propose messages are received in different orders by Lᵢ and Lⱼ. If the group becomes stable, that is, no requests for join or leave are generated in a long interval, then all non-faulty leaders eventually converge to a consistent view. They communicate this view and the associated group-key shares to all their clients who all also eventually have a consistent view of the group and the same group key.

Temporary disagreement on the group view may cause non-faulty leaders to send valid but inconsistent group-key shares to some members. This does not compromise the security requirements of Enclaves but may delay the distribution of a new group key.

Group-Key Management

The group-key management protocol relies on secure secret sharing. Each of the n leaders knows only a share of the group key, and at least f+1 shares are required to reconstruct the key. Any set of no more than f shares is insufficient. This ensures that compromise of at most f leaders does not reveal the group key to the attacker. In most secret sharing schemes, n shares Sₗ, . . . , Sₙ. are computed from a secret s and distributed to n shareholders. The shares are computed by a trusted dealer who needs to know s. In Enclaves, a new secret s and new shares must be generated whenever the group changes. This must be done online and without a dealer, to avoid a single point of failure. A further difficulty is that some of the parties involved in the share renewal process may be compromised.

A solution to these problems was devised by Cachin et al. In their protocol, the n shareholders can individually compute their share of a common secret s without knowing or learning s. One can compute s from any set of f+1 or more such shares, but f shares or fewer are not sufficient. The shares are all computed from a common value \check{g} that all shareholders know. In the preferred embodiment context, the shareholders are the group leaders and \check{g} is derived from the group view using a one-way hash function. Leader Lᵢ computes its share sᵢ using a share-generation function S, the value j, and a secret xᵢ that only Lᵢ knows: sᵢ=S(\check{g}, xᵢ). Leader Lᵢ also gives a proof that sᵢ is a valid share for \check{g}. This proof does not reveal information about x₁ but enables group members to check that sᵢ is valid.

The secrecy properties of the protocol rely on the difficulty in computing discrete logarithms in a group of large prime order. Such a group G can be constructed by selecting two large prime numbers p and q such that p=2q+1 and defining G as the unique subgroup of order q in Z*ₚ. The dealer chooses a generator g of G and performs the following operations:

Select randomly f+1 elements aₒ, . . . , a_{f} of Z_{q}.

These coefficients define a polynomial of degree f in Z_{q} [X]:

F=aₒ+aₗ,X+, . . . +a_{f}X^{f}.

Compute xₗ, . . . xₙ, of Z_{q}, and gₗ, gₙ, of G as follows:

Xᵢ=F(i)

gᵢ=g^{xi}.

The numbers xₗ, . . . , xₙ, must then be distributed secretly to the n leaders Lₗ, . . . , Lₙ, respectively. The generator g and the elements gⱼ, . . . gₙ. are made public. They must be known by all users and leaders.

Any subset of f+1 values among xₗ, . . . , xₙ. allows one to reconstruct F by interpolation, and then to compute the value aₒ=F(0). For example, given x₁, . . . , x_{f+1}, one has

$${a}_{o} = {\sum }_{i = 1}^{f + 1} {b}_{i} {x}_{i} ,$$

where bᵢ is obtained from j=1, . . . , f+1 by

$${b}_{i} \frac{{Π}_{j \neq i} j}{{\prod }_{j \neq i} ( j - i )}$$

By this interpolation method, one can compute \check{g}^{ao} for any \check{g} ε G given any subset of f+1 values among \check{g}^{xl} . . . \check{g}^{xn}. For example, from \check{g}^{xl}, . . . , \check{g}^{f+1}, one gets

$${\breve{g}}^{ao} = \frac{f + 1}{{\prod }_{i = 1} } {( {( \tilde{g} )}^{{x}_{i}} )}^{{b}_{i}} \qquad ( 1 )$$

As discussed previously, leader Lᵢ maintains a local group view (nᵢ, Mᵢ). Lᵢ's share sᵢ is a function of the group view, the generator g, and Lᵢ's secret value xᵢ. Lᵢ first computes \check{g} ε G using a one-way hash function HI:

\check{g}=H₁, (nᵢ, Mᵢ).

The share Si is then defined as

Sᵢ=\check{g}^{xi}.

The group key for the view (nᵢ, Mᵢ) is defined as

K=H₂(\check{g}^{ao}),

where H₂ is another hash function from G to {0, 1}^{k} (k is the key length). Using equation (1), a group member can compute \check{g}^{ao} given any subset of f+1 or more shares for the same group view. Under a standard intractability assumption, it is computationally infeasible to compute K knowing fewer than f+1 shares. It is also infeasible for an adversary to predict the values of future group keys K even if the adversary corrupts f leaders and has access to f secret values among xₗ, . . . xₙ.

Equation (1) allows a group member to compute \check{g}^{ao} and K from f+1 valid shares of the form Sᵢ=\check{g}^{xi}. However, a compromised leader Lᵢ could make the computation fail by sending an invalid share s_{I}≠\check{g}^{xi}. Lᵢ could also cause different members to compute different K's by sending different shares to each. To protect against such attacks, the share Sᵢ is accompanied with a proof of validity. This extra information enables a member to check that sᵢ is equal to \check{g}^{xi} with very high probability. The verification uses the public value g₁ that is known to be equal to g^{x1} (since the dealer is trusted). To prove validity without revealing xᵢ, leader Lᵢ generates evidence that

log_{\check{g}}S₁=log_{g}g₁.

To generate the evidence, Lᵢ randomly chooses a number y in Z_{q} and computes

u=g^{y}

v=\check{g}^{y}

Then Lᵢ uses a third hash function H₃ from G⁶ to Z_{q}, to compute

c=H₃(g, gᵢ, u, \check{g}, s_{i, v)}

z=y+xᵢ, c.

The proof that sᵢ is a valid share for \check{g} the pair (c, z). The information sent by Lᵢ to a group member A is then the tuple

(nᵢ,M_{I},sᵢ,c,z).

This message is sent via the secure channel established between A and Lᵢ after authentication. This prevents an attacker in control of f leaders from obtaining extra shares by eavesdropping on communications between leaders and clients.

On receiving the above message, a group member A evaluates \check{g}=H₁, (n₁, M₁) and

u₁=g^{z}/g^{c},

v¹=\check{g}^{z}/S₁^{c}.

A accepts the share as valid if the following equation holds:

c=H₃(g,gᵢ,u¹,\check{g},sᵢ,v¹)−

If this check fails, sᵢ is not a valid share and A ignores it. Once A receives f+1 valid shares corresponding to the same group view, A can construct the group key. Since A maintains a connection with at least f+1 honest leaders, A eventually receives at least f+1 valid shares for the same view, once the group becomes stable.

It has been proven computationally infeasible, in the random oracle model, for a compromised leader Lᵢ to produce an invalid share s' and two values c and z that pass the share-verification check.

Cryptographic Material

The following cryptographic keys and secret material must be distributed to the leaders and registered users:

Each leader Lᵢ must own a private key to sign messages when executing the leader-coordination protocol. The corresponding public key must be known by all the other leaders.

Lᵢ must also hold the secret xi used to generate shares of group keys. The corresponding verification key gi must be known by all the registered users.

For every registered user A and leader Lᵢ, a secret long-term key P_{a.i} is shared by A and Lᵢ. This key is used for authentication.

Communication between an application and the underlying Enclaves layer must follow the interface described hereinabove. A plugin simply needs to implement the three methods of abstract class PlugIn Method buildGUI

public abstract class PlugIn

extends Jframe implements . . . {

protected abstract void buildGUI( );

protected abstract void receiveMessage(Message m);

protected abstract void sendMessage (byte[ ] msg);

is invoked by the user interface for the application to initialize. Afterwards, communication between the application and the Enclaves middleware is performed via two methods for sending and receiving messages. When a plugin is ready to be deployed, the developer must package it and every resource it needs into a JAR file and put it in a specific directory. The new plugin is then loaded and available to users.

Currently, four basic plugins have been developed for Enclaves: a shared whiteboard application (Paint), a messaging application allowing users to send text messages (Chat), a file transfer application for multicasting data files (FTP plugin), and a Sound plugin for multicast of streaming audio. Notwithstanding the foregoing, the potential for plugins is not intended to be limited by the illustrations provided herein.

Performance

Enclaves's security requirements can be shown to theoretically hold if no more than f leaders are compromised, no group member is compromised, the attacker does not break the cryptographic algorithms, and the network assumptions are satisfied. The cryptographic and secret sharing protocols used are hard to break. If weaknesses are discovered, the Enclaves implementation makes it easy to change cryptographic primitives.

As in any group communication system, if an attacker can compromise a member machine and get hold of the group key, or if one member is non-trustworthy, then confidentiality is lost. Clearly, there is no absolute defense against this vulnerability as it is the function of the system to distribute data to all group members. Mitigating measures could be implemented, such as requiring members to periodically re-authenticate before sending them a new key, or relying on intrusion detection and expel members suspected of being compromised.

Current TCP/IP protocols make it difficult to defend against network-based denial-of-service attacks based on flooding in any system. However, the distributed architecture of Enclaves increases the resilience of the system to such attacks. A useful property is also that group communication can continue even after a successful denial-of-service attack on the leaders. Such an attack prevents new users from joining an application and the group key from being refreshed but does not immediately affect the users already in the group.

Clearly, the architecture of Enclaves improves group security only if it is substantially harder for an attacker to penetrate several leaders than a single one. Every attempt should then be made to prevent common vulnerabilities, so that the same attack does not succeed on all leaders. This requires diversity. Leaders should use different hardware and operating systems, and, as a minimum, different implementations of the Java Virtual Machine. It is also desirable to put the different leaders under the responsibility of different administrators, as a protection against the insider threat.

This invention as described in the specification, drawings and claims is intended to cover all embodiments and equivalence's that occur to a computer science practitioner or those of skill in related fields.

We claim:

1. A network communication method for establishing secure collaborative group communication among a subset of nodes in a mobile ad-hoc MANET, said method comprising the steps of:
creating a secure virtual communications channel between each member node of said subset of nodes;
managing the membership of said subset.

2. A network communication method as in claim 1 wherein determination of MANET membership includes:
establishment of MANET via protocol enabling routing node intercommunication whereby each routing node disseminates routing information to one or more neighbor nodes based on a broadcast tree maintained in part by that routing node, the routing nodes determining a path to the destination node based on the routing information.

3. A network communication method as in claim 1 wherein determination of MANET membership includes:
establishment of a MANET where the nodes intercommunicate via a protocol
wherein routing nodes each disseminate link-related information to zero or more neighbor nodes based on a tree developed and maintained by that routing node, said routing nodes operable to determine whether a link-state change in the first wireless route has interrupted communications between between the nodes and that the communicating node has accordingly selected an alternate wireless route through the network; and
a queue storing communications affected by the interruption and transmitting such communications to the client and the server to resume communications between the client and the server over the alternate wireless route from the point of interruption.

4. A wireless network communication method for mobile ad-hoc wireless network member communication said communication method comprising:
creating secure virtual groups of member nodes;
managing group membership so as to maintain group security.

5. A wireless mesh network communication method for mobile wireless network member communication, said communication method comprising:
creating secure groups of member nodes wherein more than one node acts as leader;
managing, at least partially through the acts of the leader nodes group, group membership so as to maintain group security.

6 A wireless communication system for mobile ad-hoc wireless network member communication said system comprising:
a plurality of communicating nodes wherein some nodes assume a leadership role;
and wherein the acts of at least some of the leaders maintain network communications substantially secure from unauthorized access.

7. A wireless communication system for mesh MANET member communication wherein the network layer includes protocols operable to support multicasting by member

8. The system as in claim 7 further including an Enclaves stack layer operable to create secure VPN among subset of member nodes, and interoperable with said multicasting layer so multicasting functions within the secure subset.
